(19) United States
(12) Patent Application Publication
(10) Pub. No.: US 2011/0228267 A1
(43) Pub. Date: Sep. 22, 2011

(54) REFLECTION GRATING, AND SPECTROGRAPH AND PULSE SHAPER USING THE REFLECTION GRATING

(75) Inventor: Shinichi HAYASHI, Tokyo (JP)

(73) Assignee: Olympus Corporation, Tokyo (JP)

(21) Appl. No.: 13/043,930

(22) Filed: Mar. 9, 2011

(30) Foreign Application Priority Data
Mar. 19, 2010 (JP) 2010-063497

(51) Int. Cl. G01J 3/18; G02B 5/32; G02B 5/18

(52) U.S. Cl. 356/305; 359/15

(57) ABSTRACT

A reflection grating includes a transmission hologram layer for diffracting incident light, a reflection member in contact with the transmission hologram layer, and a reflection plane for reflecting diffracted light generated by the transmission hologram layer.

### CROSS REFERENCE TO RELATED APPLICATIONS

This application is based upon and claims the benefit of priority from the prior Japanese Patent Application No. 2010-063497, filed Mar. 19, 2010, the entire contents of which are incorporated herein by this reference.

### BACKGROUND OF THE INVENTION

1. Field of the Invention

The present invention relates to a reflection grating, and a spectrograph and a pulse shaper using the reflection grating.

2. Description of the Related Art

Currently, various types of diffraction gratings are widely used as spectrum splitting means. Examples of main diffraction gratings include a surface relief grating for obtaining diffracted light by using a relief structure of a surface as disclosed by U.S. Pat. No. 5,995,281, and a volume phase holographic (VPH) grating for obtaining diffracted light by using a periodical change of an internal refractive index as disclosed by Japanese Patent Application Publication No. 2006-178223, and U.S. Pat. Nos. 7,315,371 and 6,583,873.

FIG. 1 schematically illustrates a device that is disclosed by U.S. Pat. No. 5,995,281 and includes a pulse light source 101, a microscope 102 and a pre-chirp unit 103. In FIG. 1, reflection blazed gratings (gratings 100a, 100b, 100c and 100d) that are surface relief gratings are used as spectrum splitting means within the pre-chirp unit 103.

FIG. 2 is an oblique perspective view for explaining a conceptual configuration of a diffraction grating device that is disclosed by Japanese Patent Application Publication No. 2006-178223. In FIG. 2, a transmission grating 201 that is a VPH grating is arranged between right-angle prisms 202 and 203 within the grating device configured as a so-called grism.

FIG. 3 illustrates an optical design of a spectrum disperser that is disclosed by U.S. Pat. No. 7,315,371 and included in a spectrum analyzer. In FIG. 3, a planar transmission grating 301 (VPH grating) is arranged between a lens 303 and a lens group 304, which are arranged in an optical path leading to a detector array 302.

FIG. 4 schematically illustrates a spectrograph disclosed by U.S. Pat. No. 6,583,873. In FIG. 4, a volume dispersion grating 401 (volume dispersion grating 402) that is a VPH grating is arranged along with a mirror 405 (mirror 406) on a turret 404 arranged in an optical path leading to a detector 403.

Normally, it is preferable that diffraction gratings used as spectrum splitting means have high diffraction efficiency in a wide wavelength range in order to use light rays having various wavelengths with high efficiency.

A VPH grating can achieve relatively high diffraction efficiency in comparison with a surface relief grating, and the diffraction efficiency of primary diffracted light sometimes exceeds 90 percent at the maximum. In contrast with the surface relief grating, in which a wavelength that achieves the highest diffraction efficiency (hereinafter referred to as an optimum wavelength) is nearly constant with almost no change with an incidence angle, the VPH grating can adjust an optimum wavelength. Specifically, the VPH grating can achieve the highest diffraction efficiency with the wavelength of light emitted at an angle equal to an incidence angle. Therefore, the optimum wavelength can be arbitrarily adjusted by changing the incidence angle to be nearly equal to an angle at which primary diffracted light having a desired wavelength is emitted.

Accordingly, diffraction efficiency of 80 percent or more can be achieved in almost the whole of a wavelength range by adjusting the optimum wavelength with the use of the VPH grating, whereby high diffraction efficiency can be realized in a wide wavelength range.

The device disclosed by Japanese Patent Application Publication No. 2006-178223 has prisms (right-angle prism 202, right-angle prism 203) preceding and succeeding a VPH grating 201 in order to stabilize an optical axis regardless of an optimum wavelength. Moreover, the device has a structure for simultaneously rotating the preceding and the succeeding prisms in order to adjust the optimum wavelength.

The device disclosed by U.S. Pat. No. 7,315,371 has a structure for changing an optical axis direction by inclining optical systems preceding and succeeding a VPH grating.

The device disclosed by U.S. Pat. No. 6,583,873 has a structure for switching, with a rotation of a turret, prepared assemblies each composed of a VPH grating having a different incidence angle for each detected wavelength and a mirror.

Since the emission direction of each optimum wavelength against an incident direction to the transmission VPH grating changes as described above, the transmission VPH grating has a structure for allowing this change.

Additionally, as a VPH grating, there is a reflection VPH grating. The reflection VPH grating achieves the highest diffraction efficiency with primary diffracted light reflected in the same direction as incident light. Therefore, even if an incidence angle is changed by rotating the reflection VPH grating according to a desired wavelength, the emission direction of an optimum wavelength against the incident direction does not change. Accordingly, the optimum wavelength can be adjusted only by using a relatively simple structure such as a structure for rotating the grating itself.

### SUMMARY OF THE INVENTION

One aspect of the present invention provides a reflection grating including a transmission hologram layer for diffracting incident light, a reflection member in contact with the transmission hologram layer, and a reflection plane for reflecting diffracted light generated by the transmission hologram layer.

### BRIEF DESCRIPTION OF THE DRAWINGS

The present invention will be more apparent from the following detailed description when the accompanying drawings are referenced.

FIG. 1 schematically illustrates a device including a pre-chirp unit according to a conventional technique;

FIG. 2 is an oblique perspective view for explaining a conceptual configuration of a diffraction grating device according to a conventional technique;

FIG. 3 illustrates an optical design of a spectrum disperser included in a spectrum analyzer according to a conventional technique;

FIG. 4 schematically illustrates a spectrograph according to a conventional technique;

FIG. 5 is an explanatory view of a configuration of a reflection grating used in each embodiment;

FIG. 6 is an explanatory view of a configuration of a modification example of a reflection grating used in each embodiment;

FIG. 7A is an explanatory view of a method for manufacturing the reflection grating illustrated in FIG. 5;

FIG. 7B is an explanatory view of a method for manufacturing the reflection grating illustrated in FIG. 5;

FIG. 7C is an explanatory view of a method for manufacturing the reflection grating illustrated in FIG. 5;

FIG. 7D is an explanatory view of a method for manufacturing the reflection grating illustrated in FIG. 5;

FIG. 8A is an explanatory view of another method for manufacturing the reflection grating illustrated in FIG. 5;

FIG. 8B is an explanatory view of another method for manufacturing the reflection grating illustrated in FIG. 5;

FIG. 9 is an explanatory view of a further method for manufacturing the reflection grating illustrated in FIG. 5;

FIG. 10A is an explanatory view of a method for manufacturing the reflection grating illustrated in FIG. 6;

FIG. 10B is an explanatory view of a method for manufacturing the reflection grating illustrated in FIG. 6;

FIG. 11A is a top view of a spectrograph according to a first embodiment;

FIG. 11B is a side view of the spectrograph according to the first embodiment;

FIG. 11C is a side view of the spectrograph according to the first embodiment;

FIG. 11D is a side view of the spectrograph according to the first embodiment;

FIG. 12A is a top view of a spectrograph according to a second embodiment;

FIG. 12B is a side view of the spectrograph according to the second embodiment;

FIG. 13A is a top view of a pulse shaper according to a third embodiment; and

FIG. 13B is a side view of the pulse shaper according to the third embodiment.

### DESCRIPTION OF THE PREFERRED EMBODIMENTS

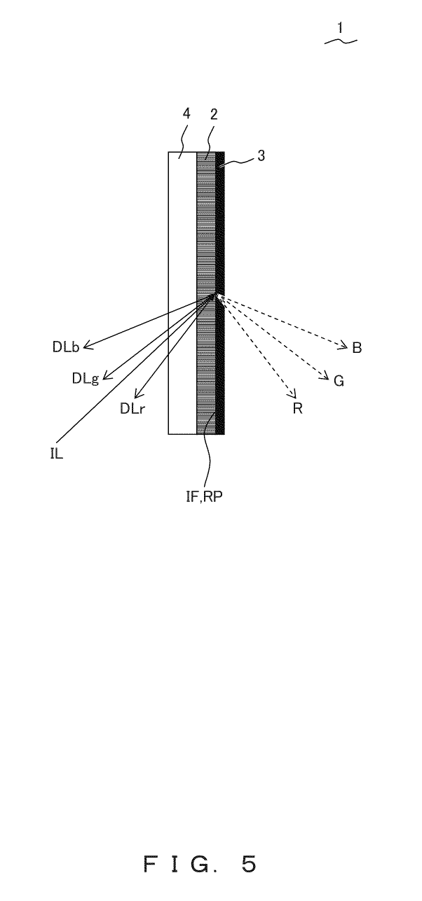

Configurations of reflection gratings used in embodiments are initially described. FIG. 5 is an explanatory view of a configuration of the reflection grating used in each embodiment.

The reflection grating 1 illustrated in FIG. 5 includes a transmission volume phase hologram layer 2 for diffracting incident light IL, a mirror 3 that is a reflection member arranged in contact with the volume phase hologram layer 2, and a protection glass 4 that is a protection member for protecting the volume phase hologram layer 2. The mirror 3 includes a reflection plane RP for reflecting diffracted light generated by the volume phase hologram layer 2.

The volume phase hologram layer 2 and the mirror 3 make contact with each other to form an interface IF. The interface IF is composed of a first plane of the volume phase hologram layer 2, and the reflection plane RP of the mirror 3. Namely, the reflection plane RP of the mirror 3 makes contact with the volume phase hologram layer 2.

The volume phase hologram layer 2 is interposed between the mirror 3 and the protection glass 4, and has a periodical change of a refractive index in a direction parallel to the reflection plane RP of the mirror 3. As a result, the volume phase hologram layer 2 has a particular wavelength dispersion characteristic, and can diffract the incident light IL in a direction different for each wavelength.

Note that the volume phase hologram layer 2 is similar to the volume phase hologram layer of the transmission VPH grating according to the conventional technique. Accordingly, the volume phase hologram layer 2 has relatively high diffraction efficiency in comparison with the surface relief grating, and exhibits the highest diffraction efficiency with light having a wavelength emitted at an angle equal to an incidence angle.

Moreover, the light incident to the hologram layer 2 makes a round trip to the hologram layer 2 via the reflection plane RP. Therefore, the thickness of the volume phase hologram layer 2, namely, a width of the volume phase hologram layer 2 in a direction orthogonal to the reflection plane RP (interface IF) may be approximately one half of the hologram layer of the conventional transmission VPH grating. More specifically, the thickness of the volume phase hologram layer 2 is thinner than 10 times of a wavelength to be detected (hereinafter referred to as a used wavelength) after a spectrum is split. The thinner the thickness of the hologram layer, the wider the wavelength range of diffracted light. Accordingly, the reflection grating 1 can secure a wide wavelength range of diffracted light, and can be downsized in comparison with conventional reflection VPH gratings.

Since the conventional reflection VPH gratings obtain reflected light (diffracted light) only by using Bragg diffraction, the thickness of the hologram layer needs to be several tens of times or more of the wavelength of light to be diffracted in order to achieve high diffraction efficiency. Accordingly, a Bragg condition needs to be satisfied with high precision. For this reason, high diffraction efficiency is achieved only in an extremely narrow wavelength range in comparison with the transmission VPH grating.

The reflection plane RP of the mirror 3 is configured with a material having a high reflectivity. The reflection plane RP may be, for example, a metal film of silver, aluminum or the like, or may be a dielectric multilayer film configured as high reflection coating having a high reflectivity in a wide wavelength range. Moreover, the mirror 3 may be a dichroic mirror that is a dielectric multilayer film where a reflection plane RP has a high reflectivity in a particular wavelength range.

The protection glass 4 is a protection member for protecting the volume phase hologram layer 2. On its surface, a reflection prevention film may be formed.

The incident light IL is incident to the reflection grating 1 from the side of the protection glass 4 of the reflection grating 1 on which the mirror 3, the volume phase hologram layer 2 and the protection glass 4 are stacked. The incident light IL incident to the reflection grating 1 is incident to the volume phase hologram layer 2 from a plane different from the plane in contact with the protection glass 4, namely, the plane different from the first plane (interface IF), and the incident light IL is diffracted.

The light diffracted by the volume phase hologram layer 2 is emitted from the first plane (interface IF) of the volume phase hologram layer 2 to the mirror 3, which reflects the light. Accordingly, the light diffracted by the reflection grating 1 is emitted in a direction symmetrical about the emission direction of the diffracted light, which is determined according to the wavelength dispersion characteristic of the volume phase hologram layer 2, with respect to the interface IF. Namely, if the volume phase hologram layer 2 has a characteristic of diffracting a red wavelength, a green wavelength and a blue wavelength respectively in an R direction, a G direction and a B direction as illustrated in FIG. 5, diffracted light rays DLr, DLg and DLb having the respective red, green and blue wavelengths are emitted in directions symmetrical about the R, G and B directions with respect to the reflection plane RP.

The diffractive efficiency of the volume phase hologram layer 2 is maximized with diffracted light having a wavelength emitted at an angle equal to an incidence angle as described above. This also applies to diffracted light after being reflected by the mirror 3. Accordingly, with the reflection grating 1 illustrated in FIG. 5, the diffracted light DLg emitted at an angle closest to the incidence angle of the incident light IL has the highest diffraction efficiency, and the diffracted light rays DLr and DLb have decreasing diffraction efficiency in this order.

With the reflection grating 1 illustrated in FIG. 5, high diffraction efficiency can be achieved in a wide wavelength range by changing the incidence angle of light similarly to the conventional transmission VPH grating. Moreover, diffracted light that achieves the highest diffractive efficiency can be always emitted in the same direction as incident light and in an opposite orientation similarly to the conventional reflection VPH grating. Accordingly, an optimum wavelength can be adjusted by using a relatively simple structure such as a structure for rotating the reflection grating 1 itself with a rotational axis that is parallel to the planes of the reflection grating and orthogonal to a periodical change direction of a refractive index distribution.

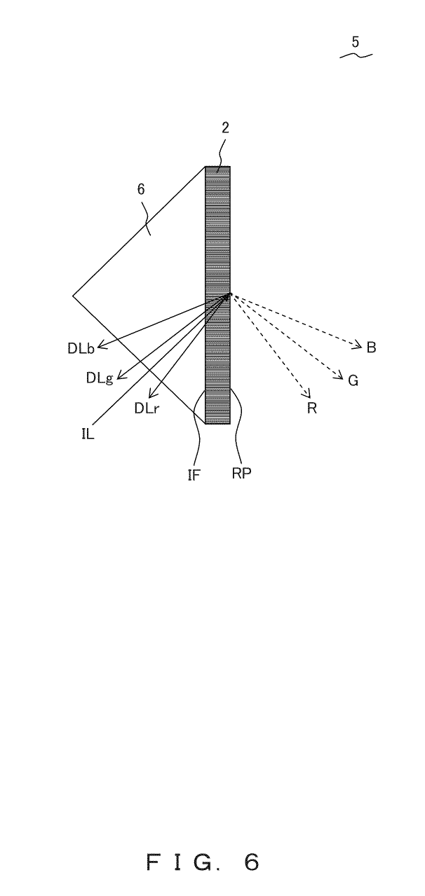

FIG. 6 is an explanatory view of a configuration of a modification example of the reflection grating used in each embodiment.

The reflection grating 5 illustrated in FIG. 6 is different from the reflection grating 1 illustrated in FIG. 5 in a point of including a total reflection prism 6 as a reflection member as an alternative to the mirror 3, and in a point that the volume phase hologram layer 2 includes the reflection plane RP for reflecting diffracted light generated by the volume phase hologram layer 2. The reflection plane RP is a plane different from the first plane (interface IF) in contact with the total reflection prism 6 in the volume phase hologram layer 2, and is a plane parallel to the first plane. In FIG. 6, a protection member for protecting the volume phase hologram layer 2 is omitted. However, the reflection grating 5 may have a protection member, and the volume phase hologram layer 2 may be interposed between the total reflection prism 6 and the protection member.

The volume phase hologram layer 2 and the total reflection prism 6 make contact with each other to form an interface IF. The interface IF is configured with the first plane of the volume phase hologram layer 2 and an oblique plane of the total reflection prism 6.

The incident light IL is incident to the reflection grating 5 from the side of the total reflection prism 6 of the reflection grating 5 on which the volume phase hologram layer 2 and the total reflection prism 6 are stacked. The incident light IL incident to the reflection grating 5 is incident to the volume phase hologram layer 2 from the first plane (interface IF) of the volume phase hologram layer 2 in contact with the oblique plane of the total reflection prism 6. The refractive index of the total reflection prism is close to that of the volume phase hologram layer 2. Accordingly, the incident light IL is incident to the volume phase hologram layer 2 with almost no reflection on the interface IF, and is diffracted.

The light diffracted by the volume phase hologram layer 2 is totally reflected on the reflection plane RP (that is the plane of the volume phase hologram layer in contact with the air, and is the total reflection plane). Accordingly, also the light diffracted by the reflection grating 5 is emitted in a direction symmetrical about the emission direction of the diffracted light, which is determined according to the wavelength dispersion characteristic of the volume phase hologram layer 2, with respect to the reflection plane RP.

Accordingly, also with the reflection grating 5 illustrated in FIG. 6, effects similar to those produced by the reflection grating 1 can be obtained.

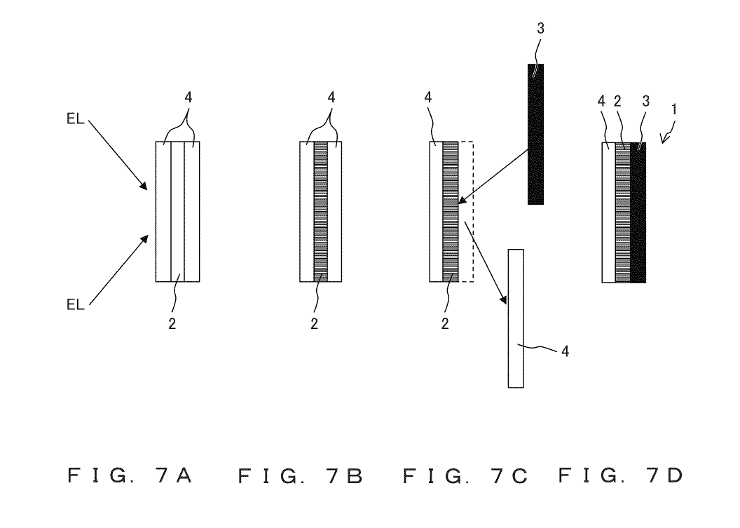

FIGS. 7A, 7B, 7C and 7D are explanatory views of methods for manufacturing the reflection grating illustrated in FIG. 5.

Initially, protection glasses 4 are arranged on both side surfaces of a hologram material to later become the volume phase hologram layer 2, such as gelatin or the like, as illustrated in FIG. 7A. Then, exposure light EL that is laser light is illuminated on the hologram material in two directions. It is preferable that the exposure light EL is incident in two directions symmetrical with respect to a normal of the hologram material via the protection glass 4 provided on either of the side surfaces of the hologram material. By illuminating the exposure light EL, interference fringes are generated on the hologram material. As a result, the refractive index of the hologram material periodically changes as illustrated in FIG. 7B, and the volume phase hologram layer 2 is formed. Lastly, as illustrated in FIG. 7C, the protection glass 4 provided on either of the sides of the hologram material is removed, and the mirror 3 is arranged instead, so that a reflection grating 1 illustrated in FIG. 7D is implemented.

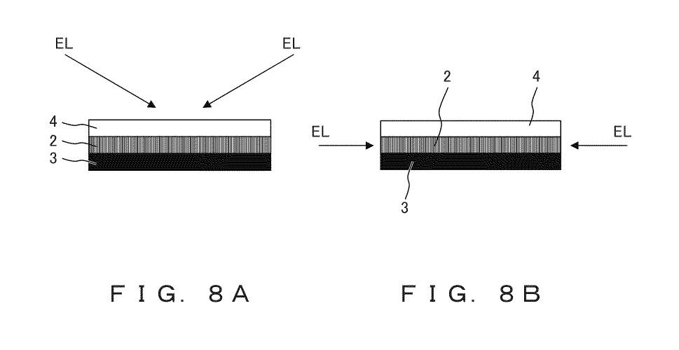

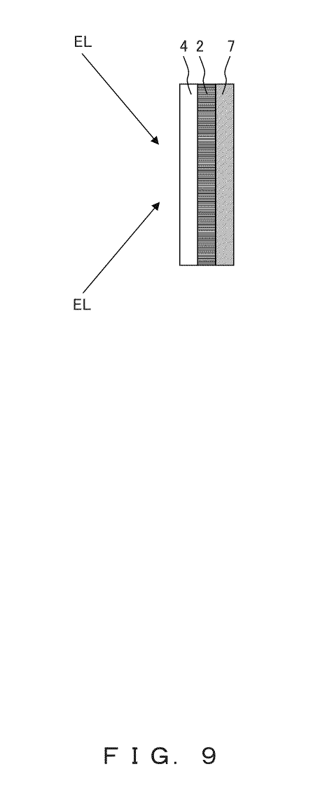

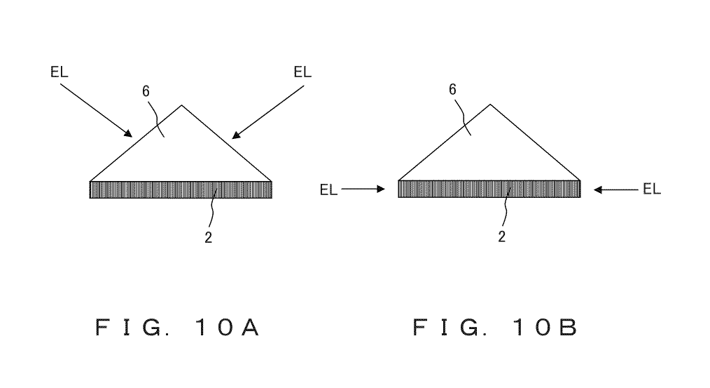

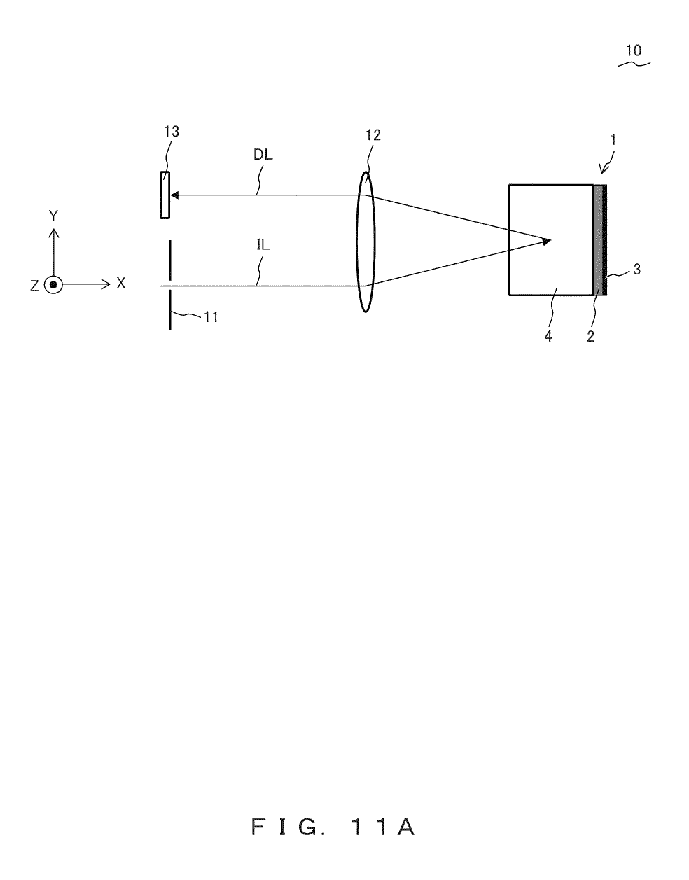

FIGS. 8A and 8B are explanatory views of another method for manufacturing the reflection grating illustrated in FIG. 5. FIG. 9 is an explanatory view of a further method for manufacturing the reflection grating illustrated in FIG. 5.

As illustrated in FIG. 8A, the volume phase hologram layer 2 may be formed by illuminating the exposure light EL on the hologram material after being interposed between the mirror 3 and the protection glass 4. Moreover, in this case, the exposure light EL may be illuminated on the hologram material in two directions parallel to the reflection plane of the mirror 3 as illustrated in FIG. 8B in order to avoid the exposure light EL from being reflected on the reflection plane of the mirror 3.

Additionally, as illustrated in FIG. 9, the volume phase hologram layer 2 may be formed by illuminating the exposure light EL on the hologram material after being interposed between a dichroic mirror 7 and the protection glass 4. By using the dichroic mirror 7 having a characteristic of transmitting the exposure light EL as an alternative to the mirror 3 having a high reflectivity in a wide wavelength range, the exposure light EL can be avoided from being reflected on the reflection plane of the dichroic mirror 7.

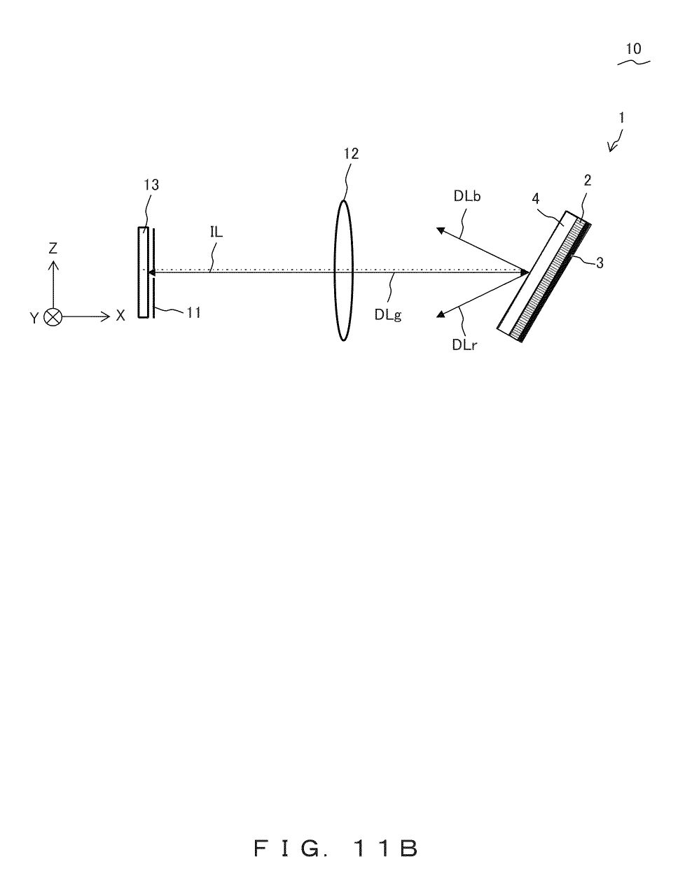

Also the reflection grating 5 illustrated in FIG. 6 can be manufactured with a method almost similar to that of the reflection grating 1 illustrated in FIG. 5. FIGS. 10A and 10B are explanatory views of a method for manufacturing the reflection grating illustrated in FIG. 6.

As illustrated in FIG. 10A, the volume phase hologram layer 2 may be formed by illuminating the exposure light from the side of the total reflection prism 6 after stacking the hologram material and the total reflection prism 6. Moreover, in this case, the exposure light EL may be illuminated on the hologram material in two directions parallel to the total reflection plane of the total reflection prism 6 as illustrated in FIG. 10B in order to avoid the exposure light EL from being reflected on the interface between the total reflection prism 6 and the volume phase hologram layer 2.

Note that the methods for manufacturing the reflection grating 1 illustrated in FIG. 5 and the reflection grating 5 illustrated in FIG. 6 are not limited to that illustrated in FIGS. 7A, 7B, 7C and 7D, that illustrated in FIGS. 8A and 8B, that illustrated in FIG. 9, and that illustrated in FIGS. 10A and 10B.

Embodiments are described below with reference to the drawings.

### First Embodiment

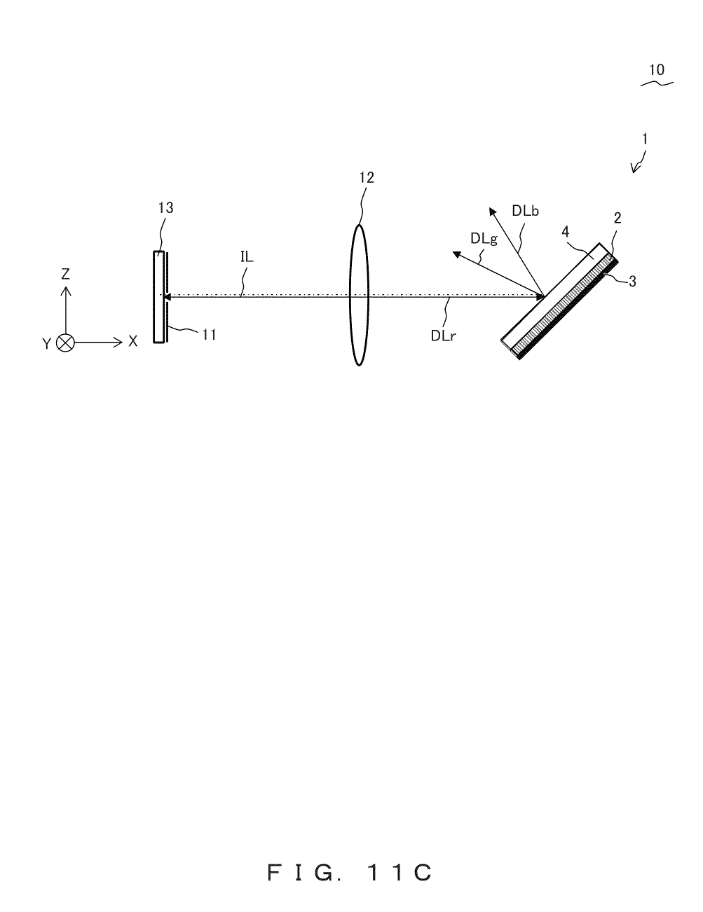

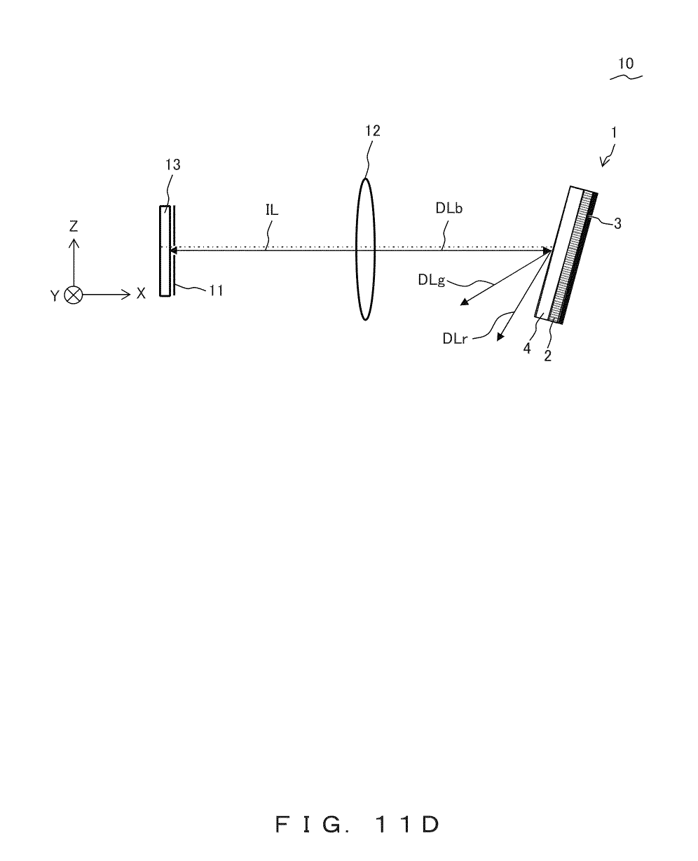

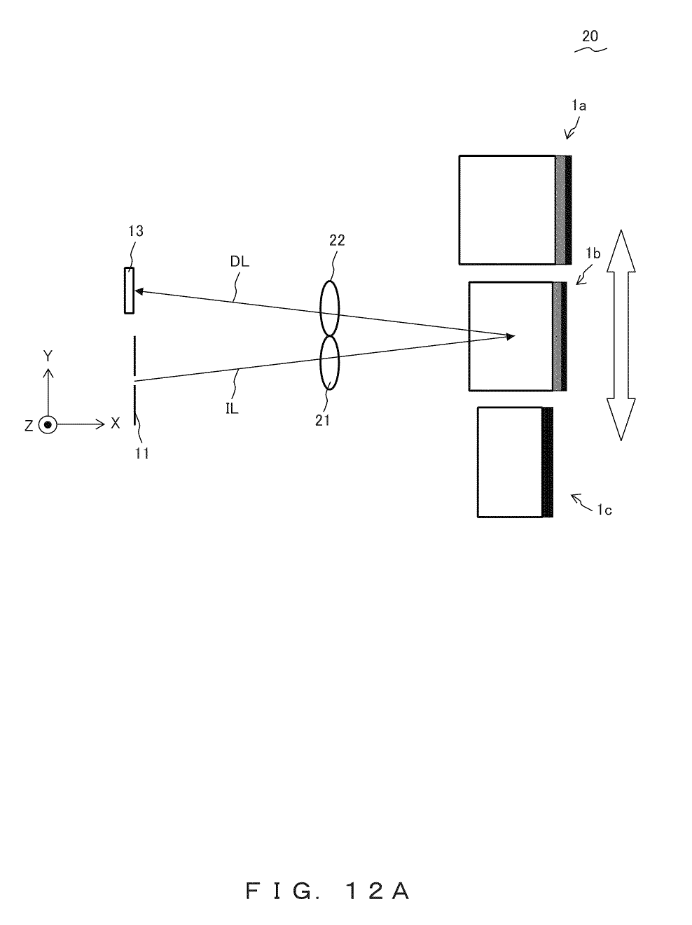

FIG. 11A is a top view of a spectrograph according to this embodiment. FIGS. 11B, 11C and 11D are side views of the spectrograph according to the embodiment, inclined at different inclination angles. An XYZ coordinate system of FIGS. 11A, 11B, 11C and 11D is a right-handed orthogonal coordinate system provided for the sake of referencing directions.

A spectrograph 10 illustrated in FIG. 11A includes the reflection grating 1 including the volume phase hologram layer 2, the mirror 3 and the protection glass 4, an incident slit 11 through which the incident light IL passes, a lens 12 for collimating the incident light IL and for collecting diffracted light DL, and a detector 13 for detecting the diffracted light.

The incident light IL that passes through the incident slit 11 is collimated by the lens 12 and incident to the reflection grating 1. Within the reflection grating 1, the incident light IL is diffracted by the volume phase hologram layer 2, and the diffracted light DL from the volume phase hologram layer 2 is reflected on the reflection plane of the mirror 3. The diffracted light DL that is reflected on the reflection plane is emitted from the reflection grating 1, and collected on the detector 13 by the lens 12. Accordingly, the diffracted light rays that are diffracted and reflected in different directions for respective wavelengths are collected in respectively different areas on a photo-detecting plane of the detector 13.

To simultaneously detect diffracted light rays having a plurality of wavelengths, which are collected in different areas, it is preferable that the detector 13 is an area sensor (two-dimensional sensor) or a line sensor (one-dimensional sensor) where a plurality of photo-detecting elements are arranged in the shape of a grid or in a line.

Additionally, the spectrograph 10 is structured so that the reflection grating 1 is rotated about a rotational axis parallel to the Y axis. Accordingly, the spectrograph 10 can arbitrarily change the inclination angle of the reflection plane of the mirror 3 for the incident light IL. It is preferable that the rotational axis includes an intersection between the optical axis of the lens 12 and the reflection grating 1.

FIG. 11B illustrates a state where the reflection grating 1 rotates and the direction of the incident light IL matches that of the diffracted light DLg having the green wavelength. More strictly, this indicates the state where the direction of the incident light IL matches that of the diffracted light DLg having the green wavelength on an XZ plane orthogonal to the rotational axis. In this case, the green wavelength is an optimum wavelength that can achieve the highest diffraction efficiency, and the spectrograph 10 can detect the diffracted light DLg with the highest diffraction efficiency.

FIG. 11C illustrates a state where the reflection grating 1 rotates and the direction of the incident light IL matches that of the diffracted light DLr having the red wavelength. In this case, the red wavelength is an optimum wavelength that can achieve the highest diffraction efficiency, and the spectrograph 10 can detect the diffracted light DLr with the highest diffraction efficiency.

FIG. 11D illustrates a state where the reflection grating 1 rotates and the direction of the incident light IL matches that of the diffracted light DLb having the blue wavelength. In this case, the blue wavelength is an optimum wavelength that can achieve the highest diffraction efficiency, and the spectrograph 10 can detect the diffracted light DLb with the highest diffraction efficiency.

As described above, with the spectrograph 10 according to this embodiment, an optimum wavelength can be arbitrarily adjusted by changing the incidence angle of light, namely, an angle with respect to the reflection plane of the incident light IL incident to the reflection grating 1. As a result, high diffraction efficiency can be achieved in a wide wavelength range. Moreover, the spectrograph 10 according to this embodiment can adjust the optimum wavelength by rotating the reflection grating itself, whereby the complexity of the configuration and the size of the device can be prevented from increasing.

This embodiment refers to the example where the optimum wavelength is adjusted to the three wavelengths such as red, green and blue. However, the embodiment is not limited to this one. Moreover, this embodiment refers to the spectrograph 10 including the reflection grating 1 illustrated in FIG. 5. However, the embodiment is not limited to this configuration. The spectrograph 10 may include the reflection grating 5 illustrated in FIG. 6.

### Second Embodiment

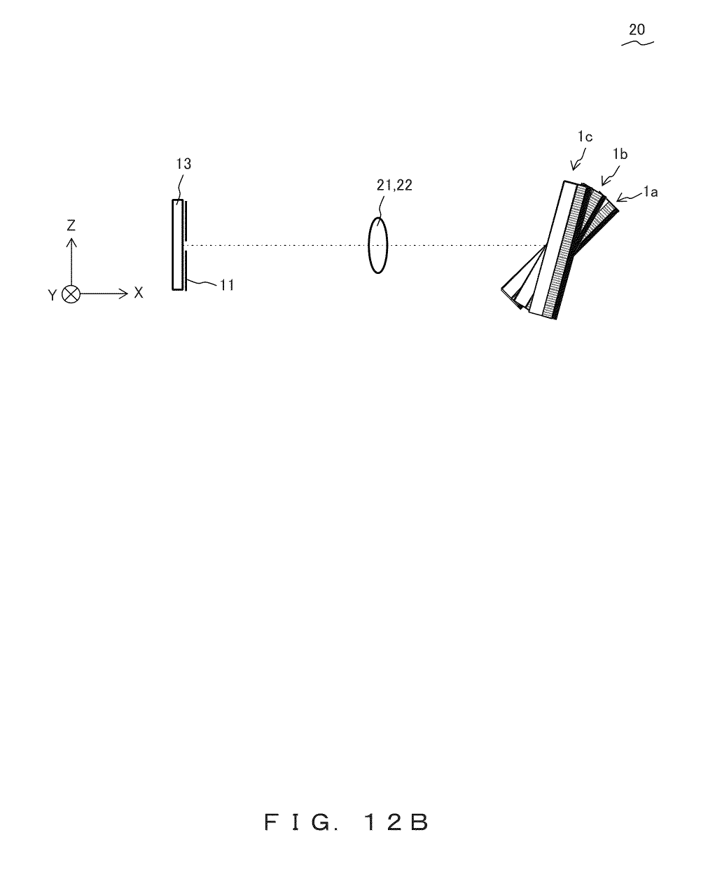

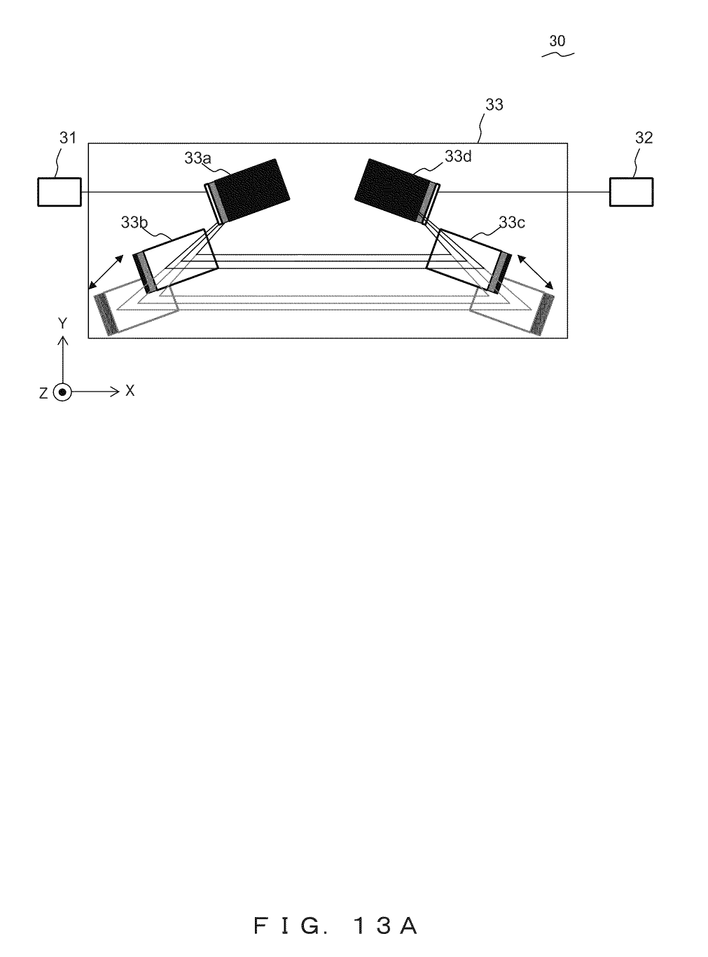

FIG. 12A is a top view of a spectrograph according to this embodiment. FIG. 12B is a side view of the spectrograph according to the embodiment. An XYZ coordinate system of FIGS. 12A and 12B is a right-handed orthogonal coordinate system provided for the sake of referencing directions.

The spectrograph 20 illustrated in FIGS. 12A and 12B includes three reflection gratings (reflection grating 1a, reflection grating 1b, reflection grating 1c) selectively inserted in an optical path of the incident light IL, an incident slit 11 through which the incident light IL passes, a lens 21 for collimating the incident light IL, a lens 22 for collecting diffracted light DL, and a detector 13 for detecting the diffracted light.

The spectrograph 20 according to this embodiment is different from the spectrograph 10 according to the first embodiment in a point of having a structure for selectively inserting one of the three reflection gratings in the optical path of the incident light IL as an alternative to the structure for rotating the reflection grating.

Additionally, similarly to the reflection grating 1 according to the first embodiment, the reflection grating 1a, the reflection grating 1b and the reflection grating 1c respectively include the volume phase hologram layer, the mirror and the protection glass. However, the reflection grating la, the reflection grating 1b and the reflection grating 1c have reflection planes with different inclination angles with respect to the incident light IL despite having the same wavelength dispersion characteristic. Accordingly, the reflection gratings exhibit mutually different optimum wavelengths.

With the spectrograph 20 according to this embodiment, an optimum wavelength can be arbitrarily adjusted by changing an angle with respect to the reflection plane of the incident light IL with switching among the reflection gratings to be inserted in the optical path. As a result, high diffraction efficiency can be achieved in a wide wavelength range similarly to the spectrograph 10 according to the first embodiment. Moreover, with the spectrograph 20 according to this embodiment, the inclination angle of the reflection plane is adjusted and fixed in advance, whereby a desired wavelength can be made to match the optimum wavelength with high precision.

Also this embodiment refers to the spectrograph 20 including the reflection grating 1 illustrated in FIG. 5. However, the embodiment is not limited to this configuration. The spectrograph 20 may include the reflection grating 5 illustrated in FIG. 6. Moreover, this embodiment refers to the spectrograph 20 including the three reflection gratings. However, the embodiment is not limited to this configuration. The number of reflection gratings may be any plural number.

### Third Embodiment

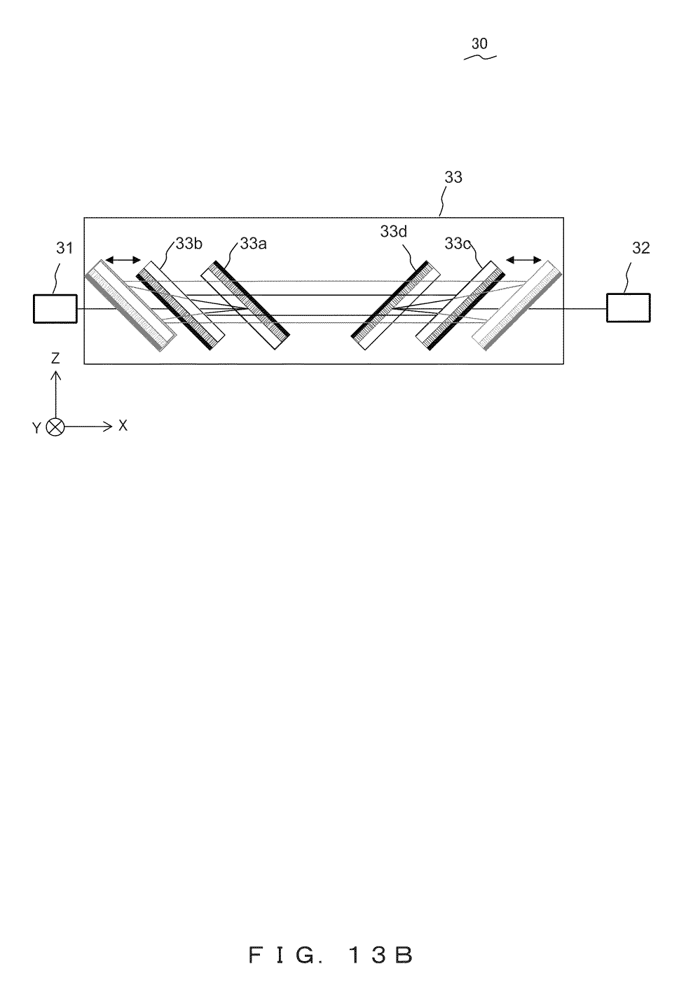

FIG. 13A is a top view of a pulse shaper according to this embodiment. FIG. 13B is a side view of the pulse shaper according to this embodiment. An XYZ coordinate system of FIGS. 13A and 13B is a right-handed orthogonal coordinate system provided for the sake of referencing directions.

The pulse shaper 30 according to this embodiment includes a pulse light source 31, a microscope 32 and a pre-chirp unit 33. The pre-chirp unit 33 includes a reflection grating 33a, a reflection grating 33b, a reflection grating 33c and a reflection grating 33d. The reflection gratings 33a to 33d have a configuration similar to the above described reflection grating 1. Moreover, the reflection gratings 33a to 33d may have a configuration similar to the above described reflection grating 5.

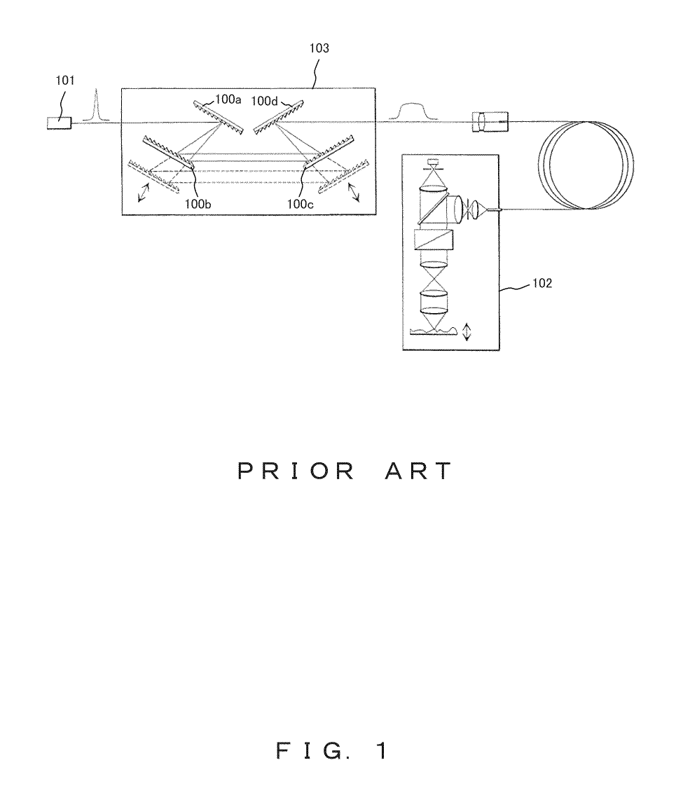

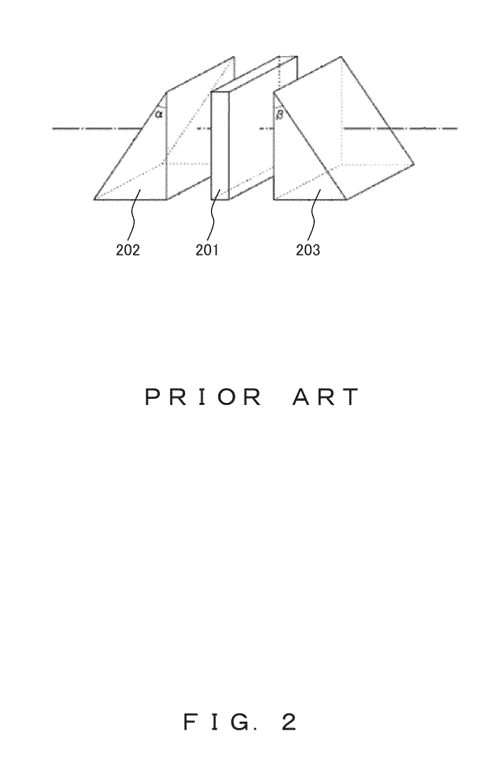

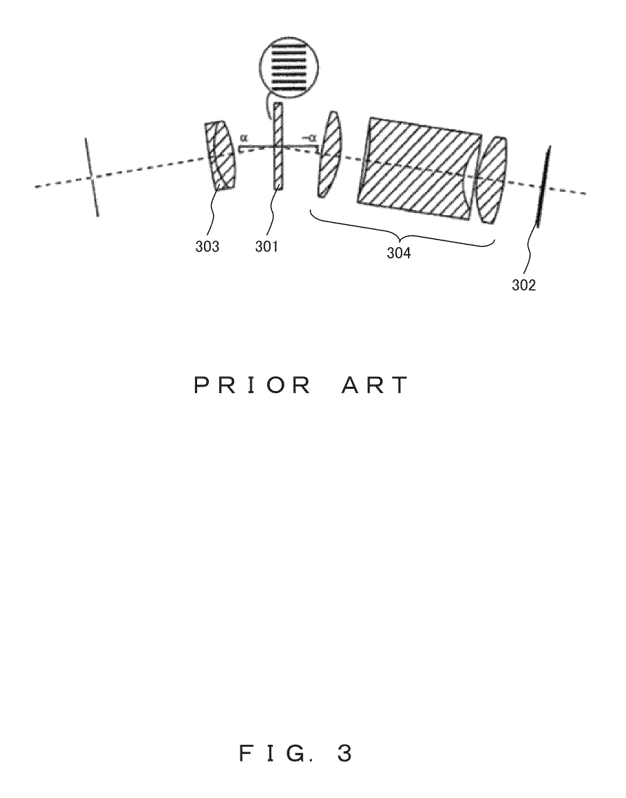

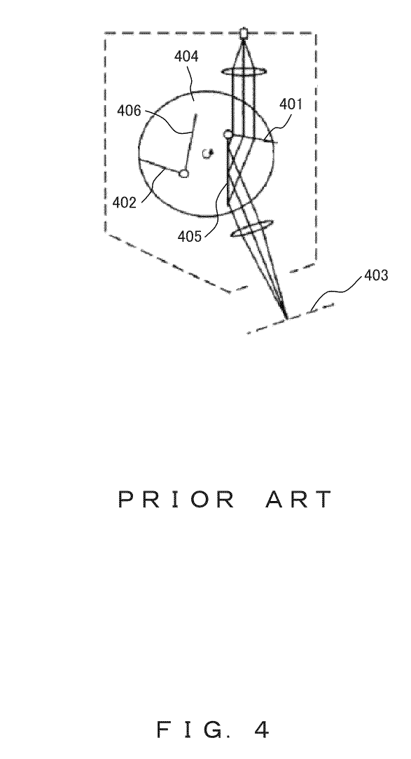

Diffraction directions of the pre-chirp unit 33 in this embodiment are orthogonal to those of the conventional pre-chirp unit 103 illustrated in FIG. 1. Accordingly, as illustrated in FIG. 13B, light having an optimum wavelength (central wavelength) diffracted by the reflection grating is superposed with light incident to the pre-chirp unit 33. FIGS. 13A and 13B illustrate only light rays respectively having the longest and the shortest wavelengths of the diffracted light, and omit a light ray having the central wavelength.

According to this embodiment, the pre-chirp unit 33 includes the above described reflection grating 1 or reflection grating 5 as an alternative to the conventional surface relief grating, whereby the diffraction efficiency of the pre-chirp unit 33 can be improved. As a result, the pulse shaper 30 according to this embodiment can prevent the transmissivity of the whole device from decreasing.

What is claimed is:

1. A reflection grating, comprising:
a transmission hologram layer for diffracting incident light;
a reflection member in contact with the transmission hologram layer; and
a reflection plane for reflecting diffracted light generated by the transmission hologram layer.

2. The reflection grating according to claim 1, wherein
the transmission hologram layer diffracts the incident light in a different direction for each wavelength.

3. The reflection grating according to claim 1, wherein
the transmission hologram layer has a periodical change of a refractive index in a direction parallel to the reflection plane.

4. The reflection grating according to claim 2, wherein
a thickness of the transmission hologram layer in a direction orthogonal to the reflection plane is thinner than ten times of a used wavelength.

5. The reflection grating according to claim 2, wherein:
the reflection member is a mirror;
the mirror includes the reflection plane in contact with the transmission hologram layer; and
the incident light is incident to the transmission hologram layer from a plane different form a first plane of the transmission hologram layer in contact with the reflection plane.

6. The reflection grating according to claim 5, further comprising
a protection member for protecting the transmission hologram layer, wherein
the transmission hologram layer is interposed between the mirror and the protection member.

7. The reflection grating according to claim 6, wherein
the reflection plane of the mirror is a metal film.

8. The reflection grating according to claim 6, wherein
the reflection plane of the mirror is a dielectric multilayer film.

9. The reflection grating according to claim 2, wherein:
the reflection member is a total reflection prism;
the transmission hologram layer comprises
a first plane in contact with the total reflection prism, and
the reflection plane; and
the incident light is incident from the first plane to the transmission hologram layer.

10. A spectrograph, comprising
the reflection grating according to claim 1.

11. The spectrograph according to claim 10, wherein:
the reflection grating has a reflection plane for reflecting the diffracted light; and
an inclination angle of the reflection plane with respect to the incident light is variable.

12. The spectrograph according to claim 10, further comprising
a plurality of reflection gratings selectively inserted in an optical path of the incident light, wherein
each of the plurality of reflection gratings reflects the diffracted light and has a reflection plane having a different inclination angle with respect to the incident light.

13. The spectrograph according to claim 12, wherein
the plurality of reflection gratings have a same wavelength dispersion characteristic.

14. A pulse shaper, comprising
the reflection grating according to claim 1.
